(19) United States
(12) Patent Application Publication
(10) Pub. No.: US 2003/0210417 A1
(43) Pub. Date: Nov. 13, 2003

(54) Driverless network EMF printing solution

(76) Inventors: John M. Haltmeyer, Clarksville, MD (US); Eric Musgrave, Sykesville, MD (US); Andrew Parlette, Sykesville, MD (US)

Correspondence Address: ROYAL W. CRAIG, A PROFESSIONAL CORPORATION, SUITE 153, 10 NORTH CALVERT STREET, BALTIMORE, MD, 21202, US

(21) Appl. No.: 10/382,483

(22) Filed: Mar. 5, 2003

Related U.S. Application Data
(60) Provisional application No. 60/361,426, filed on Mar. 5, 2002.

(51) Int. Cl. G06F 15/00; B41F 1/00

(52) U.S. Cl. 358/1.13; 358/1.15

(57) ABSTRACT

In a network environment, a printer system that prints from a Windows-based Terminal Server to a printer connected to a local client terminal without requiring installation of printer-specific drivers on the server. A single printer device driver is installed on the server and from the client machine, the user prints to the server print driver, which sends the print job to the local client. When the local client receives the print file, the printer specific device driver resident on the client prints the output to the local printer. This process eliminates the need for the server to have printer-specific drivers for each local printer.

### CROSS-REFERENCE TO RELATED APPLICATIONS

The present application derives priority from U.S. provisional patent application No. 60/361,426, filed Mar. 5, 2002.

### BACKGROUND OF THE INVENTION

1. Field of the Invention

The present invention relates to network printing in a client/server environment and, more particularly, to a method for printing from a client terminal which runs applications remotely on a terminal server, and where it is desired to print to a locally attached printer at the client terminal.

2. Description of the Background

In an existing Windows-based terminal environment, there may be many client terminals connected to a central server, and many local printers attached to the client terminals. The server administrator must install printer device drivers on the central server for each printer connected to each client terminal. This process can be very tedious in large complex environments. Moreover, the server administrator must be informed when a new local printer is added to a client machine so that the appropriate printer driver may be installed on the server. This process can be fraught with errors and delays caused by lack of communication and available resources. Additionally, most printer devices were not developed for multi-user environments, so their use on the server can be unstable, and may cause the server to crash. The result of such a server crash may be a loss of data and most certainly lost human resource time and associated costs in recovering from the crash.

Enhanced Metafile Format (EMF) provides some advantages over common image printing. With existing EMF print spooling, the operating system (OS) spools all the calls that an application makes to the printer driver to a spool file. This process is similar to spooling a printer image. The OS then plays back the spool file, sending the spooled data to the print driver, thus completing the print job entirely in the background. The spooled file is initially written to disk and is read from the disk during playback and handed to the printer driver. As the printer driver prepares the printer image for printing, temporary files are created, stored, read and written, with all the activity creating the potential for adversely affecting system performance.

There have been a few known attempts to provide improved printing processes. For example, U.S. Pat. No. 5,982,996 to Snyders shows a mechanism for printer driver switching in a Windows operating system environment to allow distribution of print jobs to an output device from a single print request within an application. The system uses a server-based application configured to generate a source job in an intermediate file format comprising an output instruction file. The server application in '996 does all the work by reconfiguring the printer settings on the fly rather than despooling a print job to the client in device independent form to be printed from the client.

U.S. Pat. No. 6,337,745 to Aiello, Jr., et al. shows a method for open systems printing including routing print jobs automatically from different types of source computers to different types of printers without the source computers selecting printers for each print job. This method for open systems printing includes routing print jobs automatically from an arbitrary number of source computers to an arbitrary number of printers without the source computers selecting printers for each print job. This process also prints from the server and not the client.

U.S. Pat. No. 6,275,299 to Beck shows a printing system having multiple printers, separate print spoolers are launched for each different printer to which a print job is directed. When a document file is sent to a print manager and a spool file is created, the spool file is moved to the specific spooler associated with the printer on which the document is to be printed. Each spooler communicates directly with its associated printer, with respect to all jobs designated for that printer. The various spoolers operate in parallel, and independently of one another and the output is printed from the server.

U.S. Pat. No. 5,845,058 to Shaw, et al. shows a system wherein print jobs are automatically and transparently spooled in a device-independent format, such as an enhanced metafile format. The enhanced metafile format provides a format into which documents are readily converted and which occupies a minimal amount of storage space. Each spooled print job is asynchronously printed relative to a program that requested the print job. Such spooled print jobs are de-spooled in a background processor mode. An operating system provides the resources for converting a print job into enhanced metafile format and spooling the print job in the enhanced metafile format.

Unfortunately, none of these nor like systems provide a method for printing to a local printer in a network environment, whereby the client sends the print request to the server application, which then creates the printer device-independent print file and sends it the client for the client to print on its local printer. It would be greatly advantageous to provide a method for printing to a locally attached printer when the client terminal runs applications remotely on the server in a network environment. In such a system only one server printer driver would need to be installed on the server and the local printer drivers are installed only on the clients to which they are connected. The printer drivers for the individual local printers only need to be installed on the clients to which they are connected; there is no need to install each printer driver on the server. The server printer driver can create the print file and send to the client, which then prints the output on its local printer.

### SUMMARY OF THE INVENTION

In accordance with the above, it is an object of the present invention to provide a method for printing to any client printer in a network environment with only a printer server application (a self-configuring driver) installed on the server and the individual printer drivers installed only on the clients to which they are connected, the printer server application dynamically detecting and adapting to any client printer drivers.

It is another object of the invention to print each job independently so that an individual user can only interrupt its own print jobs and not print jobs of other users on the network.

It is yet another object to remove the physical print process from the server and place it on the client to remove some of the contention for resources on the server and to allow simultaneous printing on the local printers.

It is still another object to require minimal storage space by providing high data compression rates which allow for simultaneous printing of large complex jobs, including full-color printing, any resolution, from any printer, all while maintaining the end-users' printing preferences (as opposed to a network manager's preferences).

It is still another object to provide a device independent printing architecture with seamless end-user integration, no training needed, and which decreases server and bandwidth congestion through compression and bandwidth control.

In accordance with the above-described objects, the present invention provides a system and method for a thin client administrator to help manage printing on complex networks by eliminating the need for specific printer drivers on a terminal server. The system allows printing to any client side printer device from a single server printer driver installed on the server, without requiring installation and maintenance of a specific printer driver on the server side. Spooled Enhanced Metafile Format (EMF) data is intercepted from the server's spool file, and is sent and played back on the client's printer.

The system generally includes the following components:

A Pass Through Print Processor passes the print job to an SDServer Process to be sent to the Client for Despooling. A port monitor is normally used to transmit the despooled data to the printer. However, with the present system, the port monitor is bypassed, so its only function is to notify the spooler that the print job is being bypassed as part of normal operation.

A printer driver normally communicates with an application Graphics Display Interface (GDI) to obtain printer capabilities and with a print processor to despool the print job. According to the present invention, the SDPrint Driver only communicates with the GDI for printer capabilities because despooling is bypassed.

The SDServer process contains the communication protocol to send the spooled file to the client where the spool file is printed on the client's local printer.

The present system inclusive of the Pass Through Print Processor module and SDServer Process module may be installed on any Windows-based multi-user server environment such as, for instance Windows NT.

Once installed, when a user logs on the system is automatically launched. The SDServer process is used to communicate with the client. The SDClient process receives the spooled file from the server and prints the output on the attached local printer.

This entire process is relatively transparent to the user who simply selects print from an application and from the resulting print dialog box directs the print to the local printer.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is flow diagram illustrating the method steps of the present invention for printing from a client terminal when running an application remotely on a terminal server, where it is desired to print to a locally attached printer.

FIG. 2 is a flow diagram illustrating the method steps of the server process of the present invention.

FIG. 3 is a flow diagram illustrating the method steps of the print driver process according to the present invention.

FIG. 4 is a flow diagram illustrating the method steps of the client functions of the present invention.

Appendix A-C are exemplary source code embodying the method steps of the present invention.

### DETAILED DESCRIPTION OF THE PREFERRED EMBODIMENT

The present invention is a method and system for improved printing in a client/server environment (in which a user runs client applications remotely on a server, but needs to print to a locally attached printer). A single Printer Driver is installed on the server regardless of the number and types of local printers attached to clients on the network. From the client machine, a user prints to the server printer driver, which sends the print job to the local client. When the local client receives the print file, the printer specific device driver resident on the client prints the output to the local printer.

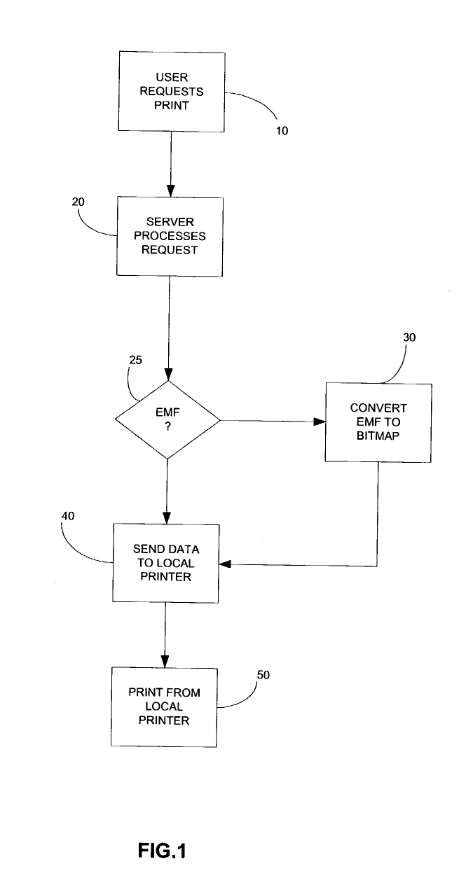

FIG. 1 is a high-level flow diagram illustrating the method steps of the present invention. The method begins at Step 10 as the user at a client terminal requests that a document be printed. The user is network-connected remotely to the server and the request is made directly at the server. This executes a single device-independent Printer Driver at the server which presents the user with a graphical user interface. Through said interface the user chooses either a Bitmap format or an Enhanced Metafile format (EMF). At Step 20, the server processes the print request via the Printer Driver.

At step 25, the Printer Driver determines whether the user has requested a Bitmap format or the Enhanced Metafile format (EMF). The choice between EMF or Bitmap is a user-programmmable feature of the Printer Driver according to the present invention.

If the user has specified bitmap, then at Step 30 the spool file is converted to Bitmap.

At Step 40, the Bitmap format or the Enhanced Metafile format is sent back to the user's client station for output to the locally-attached printer.

At Step 50, the document is printed from the client at the local printer.

The foregoing method facilitates printing to any locally-attached client printer in a network environment with only the Printer Driver installed on the server and the individual printer drivers installed only on the clients to which they are connected. The Printer Driver application dynamically detects and adapts to any and all client printer drivers as will be explained.

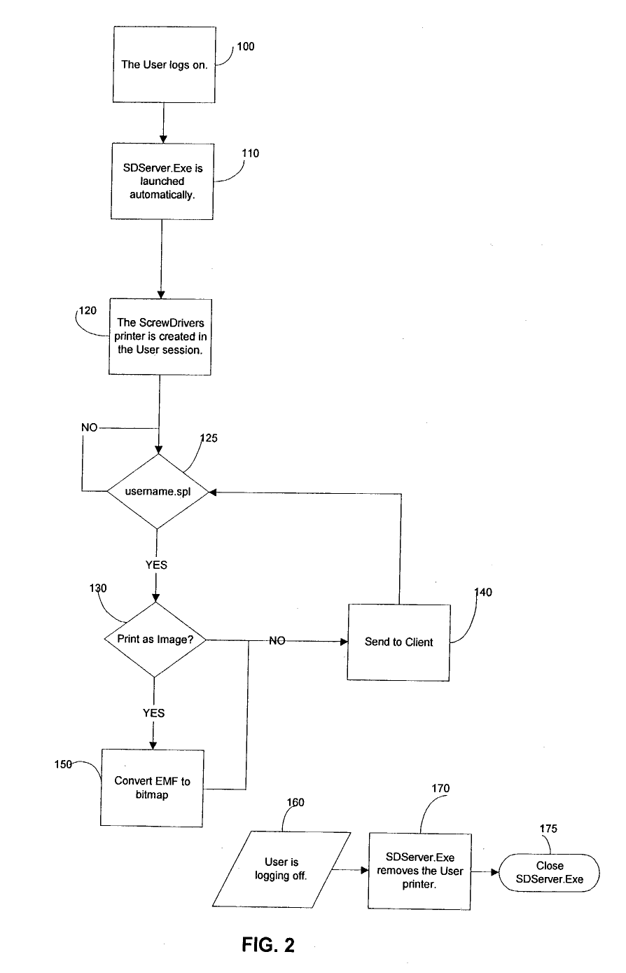

FIG. 2 is a flow diagram illustrating the detailed method steps of the Printer Driver installed on the server (SDServer) according to the present invention, from user logon to logoff. During the user's login session, the server process is invoked when a print job is found, sending the print job to the client machine.

The Server process begins at Step 100 where a user logs onto the Windows Terminal Server from a Windows-based terminal at the client. When the user logs on, SDServer is automatically launched in the user's session at Step 110.

SDServer then creates a specific user printer for the individual user at Step 120.

Next, SDServer waits for the spool file to be created at step 125. This process is accomplished by a SpoolTimer function, an example of which is shown in source code attached as Appendix A (at page 6 entitled SpoolTimerTimer). When the spool file is created, SDServer grabs the file and at step 130 prompts the user to specify whether or not they want the file in image format. If the user selects image (Bitmap) format, at Step 150 the spool file is converted to Bitmap format. If the user does not select Bitmap format the file is created in Enhanced Metafile format. This process of preparing the spool file for the client is accomplished by a ProcessPrintJob function, an example of which is shown in the source code attached as Appendix A (at pages 7-13 entitled ProcessPrintJob). At Step 140 the Bitmap format or the Enhanced Metafile format is sent to the Client. The process of sending the print file to the client is accomplished by a the SendStreamToClient function, an example of which is shown in the source code attached as Appendix A (pages 14-19). When the user logs off at Step 160 SDServer removes the specific User printer at Step 170 and exits at Step 175.

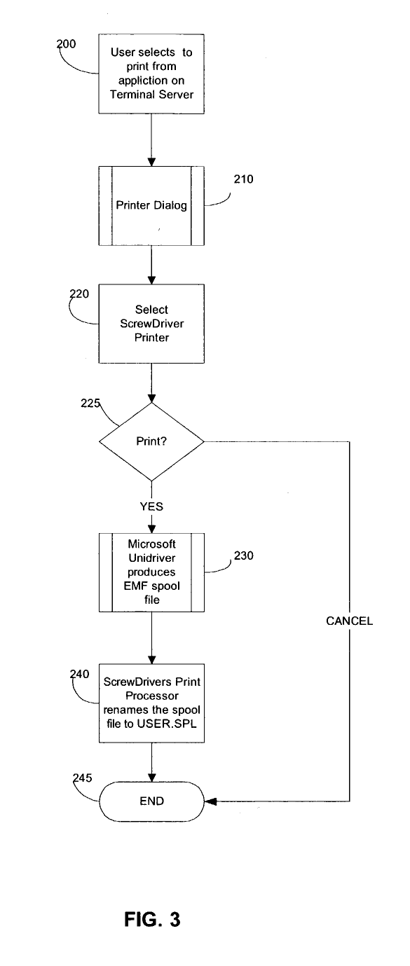

FIG. 3 is a flow diagram illustrating the detailed method steps of the Print Driver process according to the present invention. The Print Driver captures the spool file generated in EMF once the printing process begins. The end result is a spool file ready to be sent to the client. The print driver process begins at Step 200 where the user decides to print from an application on the Terminal Server. The user is presented a printer selection menu at Step 210 and the user selects the “User specific printer and clicks “Print” at Step 220. If the user does not select to print, at 225 the printing process is canceled. Continuing the print process at Step 230, the Microsoft Win32 spooler creates an EMF format spool file. The Print Processor renames the EMF spool file at Step 240 and at step 245 the print process ends.

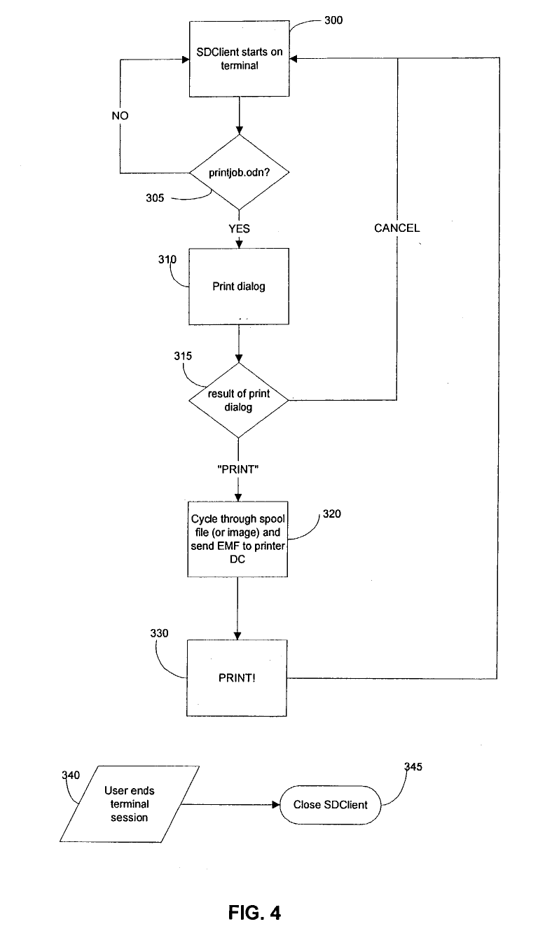

FIG. 4 is a flow diagram illustrating the detailed method steps by which the client (SDClient) functions according to the present invention. Generally, SDClient begins by receiving the print job from the server and ends by printing the output on the local physical device attached to the client machine. As seen more specifically in FIG. 4, the process begins at Step 300 where the SDClient process is launched automatically when the client terminal is booted. At 305 SDCLient waits for a file named prinjob.odn to be received from the server. This process is accomplished by a File Timer function, an example of which is shown in the source code attached as Appendix B (at page 4 entitled FileTimerTimer). The file is created by the sending/receiving mechanism built into either SDClient and SDServer or built into the Terminal Services virtual channel. When the file arrives at the Client from the Server, at Step 310, a Print Dialog is displayed to the user so that the user may select the printer on which they want the output to be printed. If, at 315, the user does not select a printer, the print job is canceled. If, on the other hand, the user selects “Print”, at Step 320, the SDClient process cycles through the received spool file and sends the print data (EMF or Bitmap) to the user's local printer. This print process is accomplished by a Print function, an example of which is shown in the source code attached as Appendix B (at page 5 entitled PrintScrewDriversPrintjob). At Step 330 the job is printed with standard Windows Spooling Architecture and the printer device driver supplied by the printer manufacturer and resident on the client terminal only.

The foregoing method inclusive of the three cooperating executables Print Driver, SDClient and SDServer modules allow printing to any client printer in a network environment with only a printer server application (SDServer) installed on the server, a client executable on the client stations (SDClient), and a Printer Driver. The three executables work together to facilitate the process beginning with receiving the print job from the server, and ending with printing the job on the attached local printer at the client station. With this method, the printer drivers for the individual local printers only need to be installed on the clients to which they are connected; there is no need to install each printer driver on the server. The server printer driver can create the print file and send to the client, which then prints the output on its local printer. each print job is printed independently so that an individual user can only interrupt its own print jobs and not print jobs of other users on the network. Moreover, the physical print process is removed from the server and is placed on the client, thereby removing some of the contention for resources on the server and allowing simultaneous printing on all local printers.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for printing in a network environment including at least one client having a locally-attached printer, and a network server for running network applications under control of said client, said method comprising the steps of:
generating a print request at said client directly to the network server via the network;
creating an Enhanced Metafile Format (EMF) spool file upon receipt of said print request;
sending the spool file from the server to the client; and
printing the output data from the client to the client's local printer

2. The method for printing in a network environment according to claim 1, wherein said step of generating a print request further comprises presenting a user at said client with a user interface that allows selection of one of an EMF and bitmap (BMP) spool file.

3. The method according to claim 2, further comprising the step of converting said EMF spool file to a BMP file before sending to the client if the user has selected BMP format.

4. The method for printing in a network environment according to claim 1, further comprising the step of said server communicating with a Graphics Display Interface (GDI) at said client to obtain said local printer capabilities.

5. A system for printing in a network environment including at least one client having a locally-attached printer, and a network server for running network applications under control of said client, the system comprising:
a device-independent printer driver resident on said server for creating an Enhanced Metafile Format (EMF) spool file upon receipt of a print request input at said client;
a client printer driver for receiving said spool file from the server printer driver and for printing to a locally-attached printer at the client.

6. The system for printing in a network environment according to claim 5, wherein the printer driver resident on said server displays a graphical user interface to a user at said client to allow user-selection of one of an EMF and bitmap (BMP) spool file.

7. The system for printing in a network environment according to claim 6, wherein the printer driver resident on said server converts said EMF spool file to a BMP file if the user selects BMP format.

8. The system for printing in a network environment according to claim 5, wherein the printer driver resident on said server communicates with a Graphics Display Interface (GDI) to obtain said local printer capabilities, and not with a print processor.

9. The system for printing in a network environment according to claim 5, wherein the device-independent printer driver and the client printer driver may be installed in any Windows-based multi-user server environment.

10. A system for printing in a network environment including at least one client having a locally-attached printer, and a network server for running network applications under control of said client, the system comprising:
means for generating a print request at said client directly to the network server via the network;
means for creating an Enhanced Metafile Format (EMF) spool file upon receipt of said print request, and for sending the spool file from the server to the client; and
means for printing the output data from the client to the client's local printer

11. The system for printing in a network environment according to claim 10, wherein the means for generating a print request further comprises a graphical user interface that allows selection of one of an EMF and bitmap (BMP) spool file.

12. The system for printing in a network environment according to claim 11, wherein the means for creating an Enhanced Metafile Format (EMF) spool file further comprises means for alternatively converting said EMF spool file to a BMP file before sending to the client if the user has selected BMP format.

13. The system for printing in a network environment according to claim 11, wherein the means for creating an Enhanced Metafile Format (EMF) spool file further comprises means for communicating with a Graphics Display Interface (GDI) at said client to obtain said local printer capabilities.
